(19) United States
(12) Patent Application Publication
(10) Pub. No.: US 2019/0191235 A1
(43) Pub. Date: Jun. 20, 2019

(54) WIRELESS EARPHONE FIXING BUCKLE

(71) Applicant: SHENZHEN SKYWALKER ELECTRONIC LIMITED, Shenzhen (CN)

(72) Inventors: King Hot Wong, Shenzhen (CN); Lei Shi, Shenzhen (CN)

(21) Appl. No.: 16/281,317

(22) Filed: Feb. 21, 2019

Related U.S. Application Data
(63) Continuation of application No. PCT/CN2018/090415, filed on Jun. 8, 2018.

(30) Foreign Application Priority Data
Nov. 22, 2017 (CN) 201711172191.X

(51) Int. Cl. H04R 1/10; H04M 1/04

(52) U.S. Cl. CPC H04R 1/105; A44B 11/00; H04M 1/04; H04R 1/1066

(57) ABSTRACT

A wireless earphone fixing buckle, being detachable connection with a wireless earphone, comprises a fixing buckle body, and the fixing buckle body comprises two parallel fixing holes extending longitudinally through the fixing buckle body, and a bottom of the fixing buckle body is provided with a slot through the fixing buckle body, and the slot is perpendicular to the fixing holes, and when the wireless earphone fixing buckle is in use, the slot is detachable connection with an external attachment, and the wireless earphone is detachable connection with the fixing holes. When the wireless earphone is not in use, the wireless earphone is fixed in the fixing holes, and the fixing buckle body is used with the strap cooperatively, to prevent the wireless earphone from being lost.

### CROSS REFERENCE TO RELATED APPLICATION

This application is a continuation application of PCT/CN2018/090415 filed on Jun. 8, 2018, which claims the benefit of Chinese Patent Application No. 201711172191.X filed on Nov. 22, 2017, the contents of which are all hereby incorporated by reference.

### FIELD OF THE INVENTION

The present application relates to the technical field of electronic device, and more particularly, to a wireless earphone fixing buckle.

### BACKGROUND OF THE INVENTION

A wireless earphone fixing buckle is easy to be lost or difficult to find, and when a user uses the wireless earphone, the wireless earphone is easy to fall or even broke under the effect of external force, and in order to prevent the wireless earphone from being lost and to facilitate placing the wireless earphone, the present application provides a wireless earphone fixing buckle.

### SUMMARY OF THE INVENTION

The embodiments of the present application provide a wireless earphone.

The technical solution of the embodiments of the present application is:

A wireless earphone fixing buckle, being detachable connection with a wireless earphone, comprises a fixing buckle body, and the fixing buckle body comprises two parallel fixing holes extending longitudinally through the fixing buckle body, and a bottom of the fixing buckle body is provided with a slot through the fixing buckle body, and the slot is perpendicular to the fixing holes, and when the wireless earphone fixing buckle is in use, the slot is detachable connection with an external attachment, and the wireless earphone is detachable connection with the fixing holes.

A preferred technical solution is: the wireless earphone fixing buckle further comprises a clamping part, and the clamping part comprises an elastic clamp and a fixing clamp, and one end of the elastic clamp is fixedly connected to one end of the fixing clamp, and the other end of the elastic clamp is in contact with the other end of the fixing clamp, and the fixing clamp passes through the slot and is detachable connection with the slot.

A preferred technical solution is: the fixing clamp is provided with at least two clamping pieces for clamping the fixing buckle body, and when the fixing clamp passes through the slot, the fixing buckle body is clamped between the clamping pieces.

A preferred technical solution is: the fixing clamp is provided with an elastic fixing buckle, and when the fixing clamp passes through the slot, the elastic fixing buckle is fastened with the slot.

A preferred technical solution is: the elastic clamp and the fixing clamp are a one-piece structure.

A preferred technical solution is: the clamping part is a stainless steel clamp.

According to the above technical solutions, the beneficial effect of the embodiments of the present application is: the fixing holes are used for fixing the wireless earphone and could be detachable connection with the wireless earphone, and an external strap could pass through the slot and is used with the slot cooperatively; when the wireless earphone is not in use, the wireless earphone is fixed in the fixing holes, and the fixing buckle body is used with the strap cooperatively, to prevent the wireless earphone from being lost; when the fixing buckle body is used with the clamping part cooperatively, the clamping part could be fixed on the clothing and the bag, to facilitate the carrying of the wireless earphone.

The above description is only an overview of the technical solutions of the present application, and the preferred embodiment will be described in detail below with reference to the accompanying drawings, to more clearly understand the technical features of the present application to implement the present application according to the description, and to make the above content, features and advantages more clearly understood.

### BRIEF DESCRIPTION OF THE DRAWINGS

FIG. 1 is a schematic diagram of a fixing buckle body according to the first embodiment of the present application;

FIG. 2 is a schematic diagram of a clamping part according to the first embodiment of the present application;

FIG. 3 is a schematic diagram of the fixing buckle body cooperating with the clamping part according to the first embodiment of the present application;

FIG. 4 is a schematic diagram of a clamping part according to the second embodiment of the present application;

FIG. 5 is a schematic diagram of the fixing buckle cooperating with the clamping part according to the second embodiment of the present application.

### DESCRIPTION OF THE EMBODIMENTS

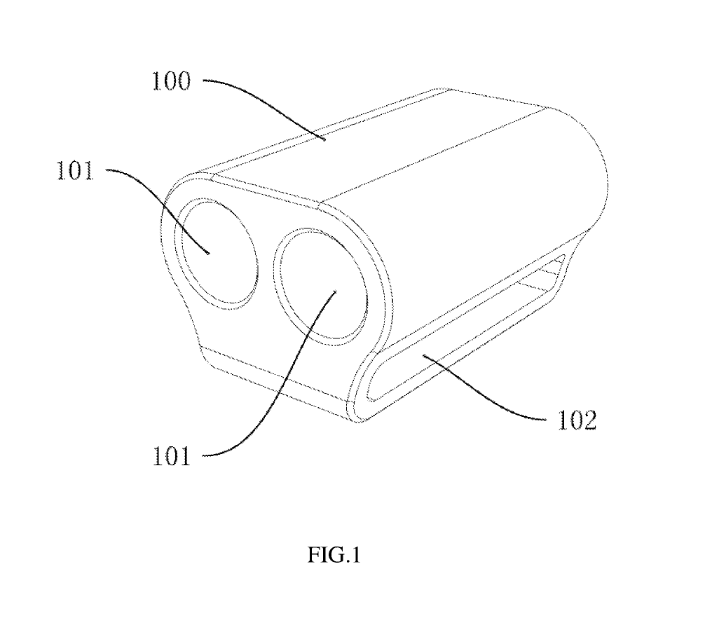

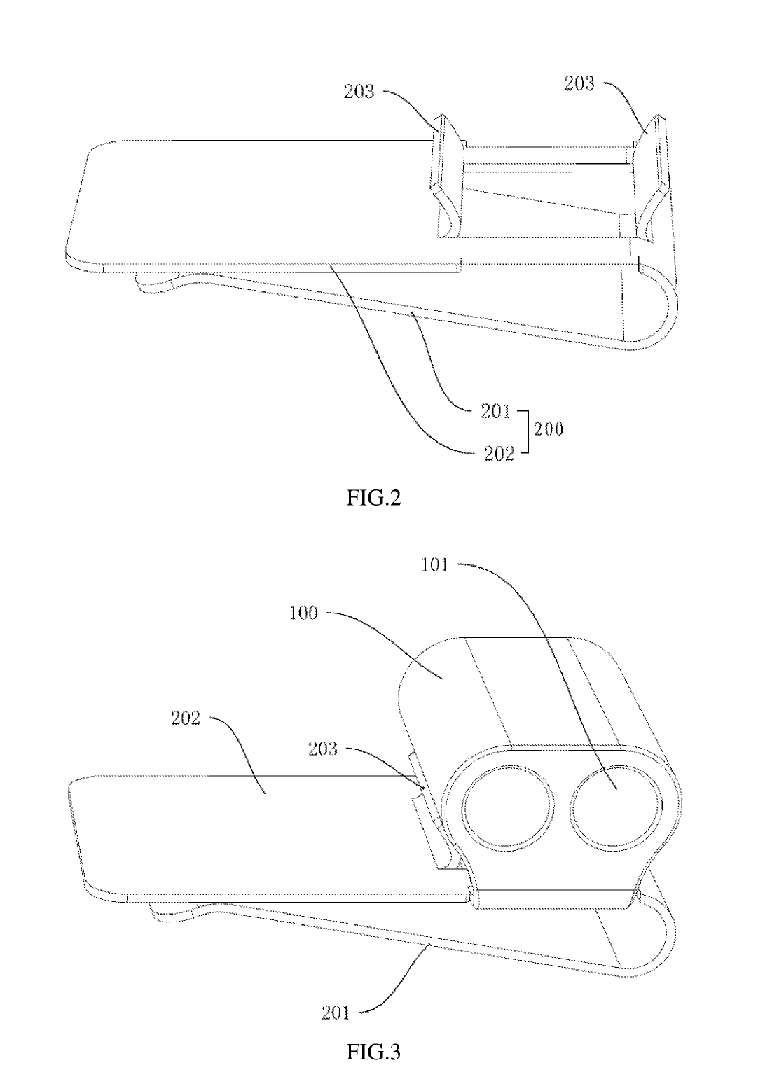

A first embodiment, as shown in FIG. 1 to FIG. 3, a wireless earphone fixing buckle, being detachable connection with a wireless earphone, comprises a fixing buckle body 100, and the fixing buckle body 100 comprises two parallel fixing holes 101 extending longitudinally through the fixing buckle body, and the bottom of the fixing buckle body 100 has a slot 102 through the fixing buckle body, and the slot 102 is perpendicular to the fixing holes 101, and when the wireless earphone fixing buckle is in use, the slot 102 is detachable connection with an external attachment, and the wireless earphone is detachable connection with the fixing holes 101. The fixing hole 101 is used for fixing the wireless earphone and could be detachable connection with the wireless earphone, and an external strap could pass through the slot 102 and is used with the slot 102 cooperatively; when the wireless earphone is not in use, the wireless earphone is fixed in the fixing holes, and the fixed buckle body 100 is used with the strap cooperatively, to prevent the wireless earphone from being lost.

As shown in FIG. 1 to FIG. 3, the wireless earphone fixing buckle further comprises a clamping part 200. The clamping part 200 comprises an elastic clamp 201 and a fixing clamp 202. One end of the elastic clamp 201 is fixedly connected to one end of the fixing clamp 202, and the other end of the elastic clamp 201 is in contact with the other end of the fixing clamp 202. The fixing clamp 202 passes through the slot 102 and is detachable connection with the slot 102. The fixing clamp 202 is provided with at least two clamping pieces 203 for clamping the fixing buckle body 100. When the fixing clamp 202 passes through the slot 102, the fixing buckle body 100 is clamped between the clamping pieces 203. When the fixing buckle body is used with the clamping part cooperatively, the clamping part 200 could be fixed on the clothing and the bag, to facilitate the carrying of the wireless earphone.

In the present application, as shown in FIG. 1 to FIG. 3, the elastic clamp 201 and the fixing clamp 202 are a one-piece structure. The clamping part 200 is a stainless steel clamp.

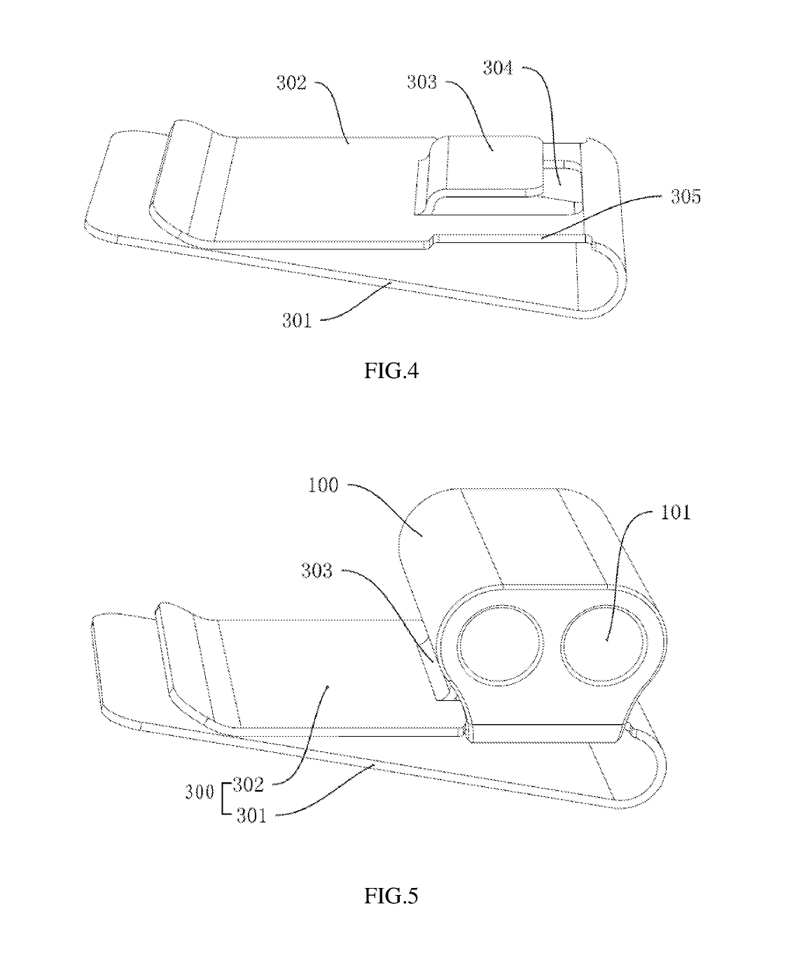

A second embodiment, as shown in FIG. 4 and FIG. 5, is different from the first embodiment in that: a clamping part 300 comprises an elastic clamp 301 and a fixing clamp 302. One end of the elastic clamp 301 is fixedly connected to one end of the fixing clamp 302, and the other end of the elastic clamp 301 is in contact with the other end of the fixing clamp 302. The fixing clamp 302 passes through the slot 102 and is detachable connection with the slot 102.

As shown in FIG. 4 and FIG. 5, the fixing clamp 302 is provided with an elastic fixing buckle 303 inserted into the slot 102. When the fixing clamp 302 passes through the slot 102, the elastic fixing buckle 303 is fastened with the slot 102. One end of the elastic fixing buckle 303 is fixedly connected to the fixing clamp 302, and the other end of the elastic fixing buckle 303 is suspended relative to the fixing clamp 302, that is, one end the elastic fixing buckle 303 is fixedly connected to the fixing clamp 302, and the other end is upwardly lifted. When the fixing clamp 302 passes through the slot 102, the slot 102 presses the elastic fixing buckle 303 downward, and the elastic fixing buckle 303 is fastened with the slot 102 under the effect of the elastic force. The fixing clamp 302 is further provided with an opening slot 304, and the opening slot 304 is located directly below the elastic fixing buckle 303. Two sides of the fixing clamp 302 are respectively provided with two notch portions 305, and when the fixing clamp 302 passes through the slot 102, the slot 302 is stuck between the notch portions 305.

The above description is the embodiments of the present application, and it should be noted that, persons skilled in the art could also make various improvements or modifications without departing from the principle of the present application, and these improvements or modifications should be considered to fall into the protection scope of the present application.

What is claimed is:

1. A wireless earphone fixing buckle, being detachable connection with a wireless earphone, comprising a fixing buckle body, wherein the fixing buckle body comprises two parallel fixing holes extending longitudinally through the fixing buckle body, and a bottom of the fixing buckle body is provided with a slot through the fixing buckle body, and the slot is perpendicular to the fixing holes, and when the wireless earphone fixing buckle is in use, the slot is detachable connection with an external attachment, and the wireless earphone is detachable connection with the fixing holes.

2. The wireless earphone fixing buckle according to claim 1, wherein the wireless earphone fixing buckle further comprises a clamping part, and the clamping part comprises an elastic clamp and a fixing clamp, and one end of the elastic clamp is fixedly connected to one end of the fixing clamp, and the other end of the elastic clamp is in contact with the other end of the fixing clamp, and the fixing clamp passes through the slot and is detachable connection with the slot.

3. The wireless earphone fixing buckle according to claim 2, wherein the fixing clamp is provided with at least two clamping pieces for clamping the fixing buckle body, and when the fixing clamp passes through the slot, the fixing buckle body is clamped between the clamping pieces.

4. The wireless earphone fixing buckle according to claim 2, wherein the fixing clamp is provided with an elastic fixing buckle, and when the fixing clamp passes through the slot, the elastic fixing buckle is fastened with the slot.

5. The wireless earphone fixing buckle according to claim 2, wherein the elastic clamp and the fixing clamp are a one-piece structure.

6. The wireless earphone fixing buckle according to claim 1, wherein the clamping part is a stainless steel clamp.

7. The wireless earphone fixing buckle according to claim 3, wherein the elastic clamp and the fixing clamp are a one-piece structure.

8. The wireless earphone fixing buckle according to claim 4, wherein the elastic clamp and the fixing clamp are a one-piece structure.
